(19) United States
(12) Patent Application Publication
(10) Pub. No.: US 2025/0384316 A1
(43) Pub. Date: Dec. 18, 2025

(54) Time-based State Control Method for Quantum Systems

(71) Applicant: University of Massachusetts, Boston, MA (US)

(72) Inventors: Loïck Le Guevel, Boston, MA (US); Joseph Bardin, Boston, MA (US)

(21) Appl. No.: 18/666,304

(22) Filed: May 16, 2024

Related U.S. Application Data
(60) Provisional application No. 63/466,835, filed on May 16, 2023.

(51) Int. Cl. G06N 10/40

(52) U.S. Cl. CPC G06N 10/40

(57) ABSTRACT

An exemplary quantum-based integrated circuit (IC) and method of time-based control are disclosed for a quantum computing system that controls the phase of the RF signal by delaying a clock signal and interpolating between the clocks as cryo-CMOS control of a fluxonium qubit. The exemplary architecture can generate control signals with tunable phase and integrated envelope values at a frequency f_{q} close or equal to the quantum transition frequency to manipulate a quantum state, e.g., for a fluxonium device or a transmons device.

### CROSS-REFERENCE TO RELATED APPLICATIONS

This application claims priority to and the benefit of U.S. provisional patent application No. 63/466,835, filed on May 16, 2023, and entitled “Time-based State Control Method for Quantum Systems,” which is incorporated herein by reference in its entirety.

### BACKGROUND

In quantum physics, a quantum system can have several energy states in which the energy spacing between quantum states defines the resonance frequency of said transition. The quantum state of the system can be manipulated by resonantly or close to resonantly driving the system at these transition frequencies.

In quantum computing, the state of a large quantum system is manipulated to perform computation. The large quantum system is made of many smaller quantum objects coupled to each other, like quantum bits (Qubit) and quantum dit (qudits), respectively, a two-state and a d-state quantum-mechanical object. Quantum processors generally employ qubit control.

Qubits are driven resonantly using an RF signal (microwave pulses) to control the duration of the drive, the amplitude, and the phase. Conventional qubit control, e.g., for superconducting and spin qubits, may use an amplitude-based control in which the phase is obtained with I-Q mixing techniques (e.g., IQ mixing a single sideband modulation), and the signal amplitude is tuned to get the targeted integrated envelope value.

Superconducting fluxonium qubits provide an alternative to transmons that may be able to potentially deploy in large-scale superconductor-based quantum computing. Their lower frequency and higher anharmonicity combined with higher coherence promise to lower the power consumption to control them with less-stringent pulse envelope shaping and slower electronics.

There is a benefit to lower the power consumption and the footprint of quantum-bit controllers to scale quantum processors with more quantum bits.

### SUMMARY

An exemplary quantum-based integrated circuit (IC) and method of time-based control are disclosed for a quantum computing system that controls the phase of the RF signal by delaying a clock signal and interpolating between the clocks as cryo-CMOS control of a fluxonium qubit. The exemplary architecture can generate control signals with tunable phase and integrated envelope values at a frequency f_{q} close or equal to the quantum transition frequency to manipulate a quantum state, e.g., for a fluxonium device or a transmons device.

Superconducting quantum processors are among the most advanced quantum computing technologies. Systems based on these devices have enabled post-classical computation [13] and proof-of-concept execution of quantum-error correction protocols [14]. While other qubit technologies employ naturally occurring quantum mechanical degrees of freedom to encode information, those used by superconducting qubits are defined at the circuit level. Today's state-of-the-art superconducting quantum processors use transmon qubits, but these are just one of a rich set of superconducting qubits; in considering the system-level optimization of a large-scale quantum computer, alternative qubit topologies may prove advantageous.

A study was conducted that developed and evaluated the exemplary quantum-based integrated circuit (IC) and method for a 22 nm FD-SOI <1.2 mW/Active-Qubit AWG-Free Cryo-CMOS controller for fluxonium qubits.

In an aspect, a system is disclosed comprising a quantum processor (e.g., fluxonium); and control electronics coupled to the quantum processor to resonantly or close to resonantly drive the quantum processor via a radiofrequency output to manipulate a quantum state, the control electronics comprising: a signal generator; and time-based control circuits coupled to the signal generator to generate the radiofrequency pulsed output with tunable phase and integrated envelope values at a frequency close to or equal to the quantum transition frequency to manipulate a quantum state.

In some embodiments, the time-based control circuits comprises: a set of cascading time delay circuits configured to receive a clock signal from the signal generator to generate a set of consecutive time-delayed clock signals; and a multiplexor and phase interpolator configured to selectively delay the set of consecutive time-delayed clock signals to control and tune phase. The consecutive time-delayed clock signals are used to finely define the integrated envelope of the radiofrequency output.

In some embodiments, the control electronics are configured to provide coarse amplitude control to tune the integrated envelope of the radiofrequency output to maintain a similar pulse duration between different integrated envelope values.

In some embodiments, the control electronics are configured to provide less than 1 mW/qubit operation.

In some embodiments, the control electronics are configured to operate at lower temperatures (e.g., at 4.2 Kelvin).

In some embodiments, the quantum processor comprises a set of transmon devices with more than 100 qubits.

In some embodiments, the quantum processor comprises a set of fluxonium devices with more than 100 qubits.

In some embodiments, the set of cascading time delay circuits is implemented in an integrated circuit, the set of cascading time delay circuits comprising a delayed-locked loop circuit, a voltage-controlled delay circuit, an equal-delay buffer inverter circuit, a phase-frequency detector circuit, or a charge pump circuit.

In some embodiments, the control electronics further includes a sequence controller and memory circuit coupled to the set of cascading time delay circuits, wherein the sequence controller is configured to retrieve a set of pulse and sequence outputs from the memory circuit and provide the retrieved set of pulse and sequence outputs as phase and amplitude control bits to the phase interpolator and output circuitry.

In some embodiments, the control electronics is configured as a 1-qubit controller.

In some embodiments, the system further includes N−1 control electronics for an N-qubit controller having N number of qubits configured to operate at different frequencies, wherein the control electronics are configured as a master mode and the N−1 control electronics configured as a slave mode.

In some embodiments, the system further includes K×N control electronics for a K×N-qubit controller having K number of qubits configured to operate at a shared frequency, and each of the K qubits having an N number of qubits configured to operate at different frequencies, wherein the control electronics is configured as a master mode and the K×N−1 control electronics configured as a slave mode.

In some embodiments, the system with K×N qubit shares part of the clock-delaying circuitry between the constant-frequency controller to lower the power consumption of the architecture.

In some embodiments, the quantum processor comprises a set of transmon devices.

In another aspect, a method is disclosed comprising: resonantly driving a quantum processor via a radiofrequency output via control electronics to manipulate a quantum state; and adjusting the radiofrequency output via time-based controls by tuning phase and integrated envelope of the radiofrequency output at a frequency close or equal to the quantum transition frequency to manipulate a quantum state.

In some embodiments, the method comprises receiving a clock signal from a signal generator; generating a set of consecutive time-delayed clock signals; and selectively delaying the set of consecutive time-delayed clock signals to control and tune the phase and integrated envelope of the radiofrequency output.

In some embodiments, the adjustments consume less than 1 mW/qubit operation.

In some embodiments, the control electronics are configured to operate at lower temperatures (e.g., at 4.2 Kelvin).

In some embodiments, the quantum processor comprises a set of fluxonium devices with more than 100 qubits.

In some embodiments, the quantum processor comprises a set of transmon devices with more than 100 qubits.

In some embodiments, the step of generating a set of consecutive time-delayed clock signals is performed using a delayed-locked loop circuit, a voltage-controlled delay circuit, an equal-delay buffer inverter circuit, a phase-frequency detector circuit, or a charge pump circuit.

In some embodiments, the method includes retrieving a set of pulse and sequence outputs from a memory circuit; and providing the retrieved set of pulse and sequence outputs as phase and amplitude control bits to adjust the radiofrequency output.

In some embodiments, the operation controls 1 qubit.

In some embodiments, the operation, as a master mode, additionally controls N−1 Qubit in slave mode.

In some embodiments, the operation, as a master mode, additionally controls (K×N)−1 qubit in slave mode.

In some embodiments, the quantum processor comprises a set of transmon devices.

### BRIEF DESCRIPTION OF THE FIGURES

The accompanying drawings, which are incorporated in and constitute a part of this disclosure, illustrate various embodiments of the present disclosure. In the drawings:

FIG. 1A shows an example quantum controller system comprising a time-based cryo-controller of a quantum device in accordance with an illustrive embodiment.

FIG. 1B shows an example method of operating the exemplary time-based quantum-bit control of FIGS. 1A-1D.

FIGS. 1C and 1D show the example cryo-CMOS controller, e.g., as the quantum controller device of FIGS. 1A and 1B, in accordance with an illustrative embodiment.

FIG. 2 shows example operations of the transmon and fluxonium qubits quantum devices.

FIG. 3 shows a high level functional description of the method of operation.

FIGS. 4A, 4B, 4C, 4D, 4E, 5A, 5B, 5C, 6, 7A, 7B, 7C show alterative circuit implementations for the various controller components of FIGS. 1A and 1B. Specifically, FIGS. 4A-4E show examples of time-based control circuits can be used as an alternative to the DLL of FIGS. 1A and 1B. FIGS. 5A-5C show examples of phase interpolation control circuits and equivalent functions can be used as an alternative to the phase interpolation circuit. FIG. 6 shows an example alternative circuit for the pulse shaper comprising Digital-to-Analog Transition, Filtering, and Gating. FIGS. 7A-7C show example controllers for the quantum circuit controller, e.g., of FIGS. 1A-1D, and FIGS. 4-6.

FIGS. 8A-8C show an N-qubit architecture, a K×N-qubit architecture, and 2-qubit architecture, respectively, that be fabricated from the quantum circuit controllers of FIGS. 1A-1D, 4A-4D, 5A-5C, 6, and 7A-7C.

FIG. 9 shows an example implementation of the time-based qubit controller in an integrated circuit for a 1-qubit device, employed in the study.

FIG. 10A shows an example setup employed in the study.

FIG. 10B-10F shows a fabricated quantum controller device and mechanical mounting assembly employed in the study.

FIGS. 11A-11B shows experimental results showing a 2-Q fluxonium device.

FIG. 12 shows a die micrograph of the protoyped IC.

FIG. 13A-13C show experimental results of the protoyped IC of FIG. 12.

### DETAILED DESCRIPTION

Each and every feature described herein, and each and every combination of two or more of such features, is included within the scope of the present invention, provided that the features included in such a combination are not mutually inconsistent.

### Example System #1

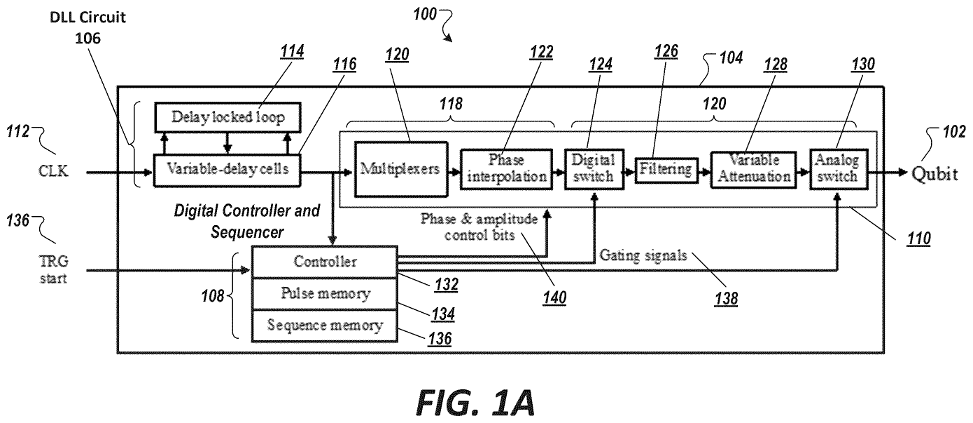

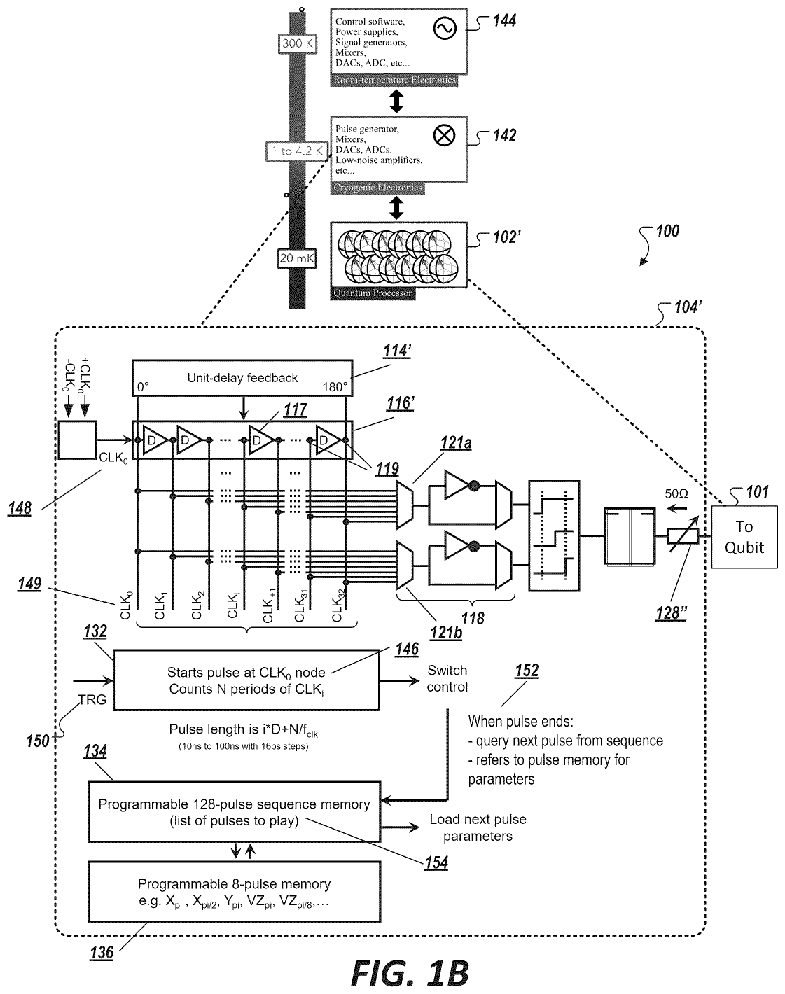

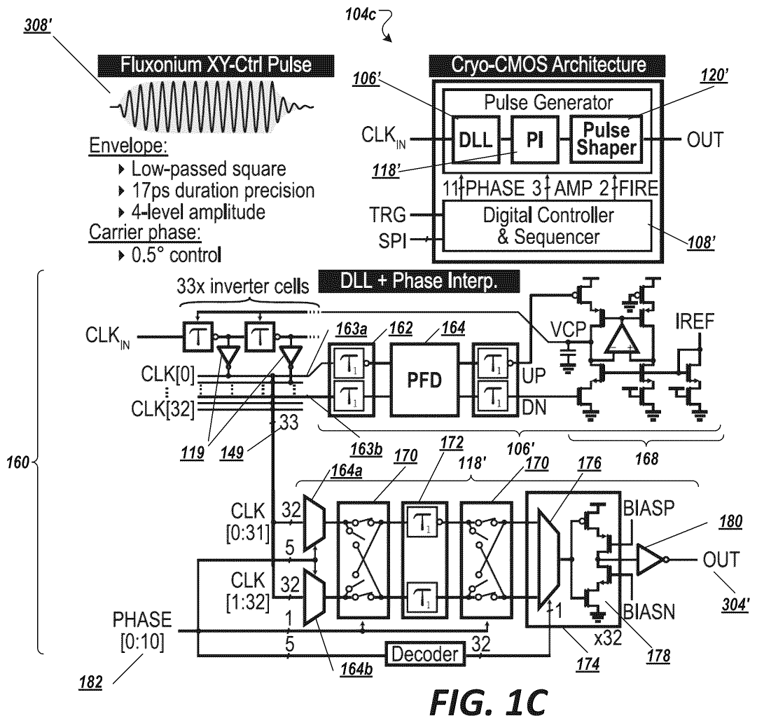

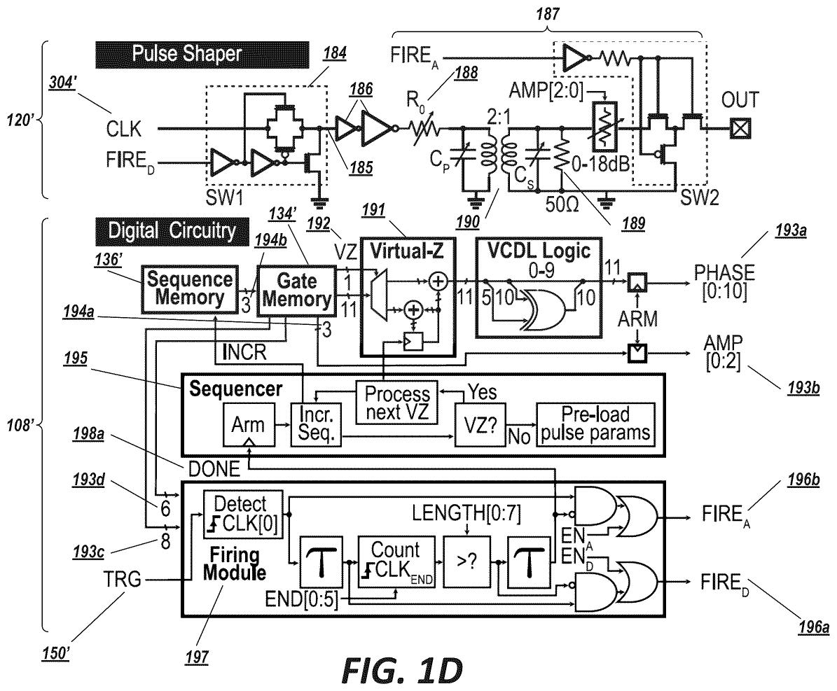

FIG. 1A shows an example quantum controller system 100 comprising a time-based cryo-controller 104 of a quantum device 102 in accordance with an illustrive embodiment. The example quantum system 100 includes a quantum processor 102, e.g., one or more Qubits (shown as “Qubit” 102a) that operates with control electronics 104. In the example shown in FIG. 1A, the control electronics include a delayed locked loop circuit 106, a digital controller and sequencer circuit 108, and a pulse generator circuit 110.

The delayed locked loop circuit 106 is operably coupled to a clock signal 112 that oscillates at a resonant frequency f₀₁ of the fluxonium, or other frequency described herein, and includes a delay locked loop 114 that operates with variable delay cells 116.

The pulse generator circuit 110 includes a phase interpolator (PI) 118 to generate a phase for the control signal for the Qubit that is followed by a pulse shaping circuit 120 to provide coarse amplitude control and fine-tuning of the pulse duration. In the example shown in FIG. 1A, the phase interpolator 118 is coupled to a multiplexer 120 and a phase interpolation circuit 122. The pulse shaping circuit 120 includes a digital switch 122, filters 124, variable attenuatino 126, and an analog switch 128.

The digital controller and sequencer circuit 108 includes a controller 132, pulse memory 134, and sequence memory 136 to provide gating signals 138 and phase and amplitude control bits 140 to the pulse generator circuit 110 as well as playback of gate sequences.

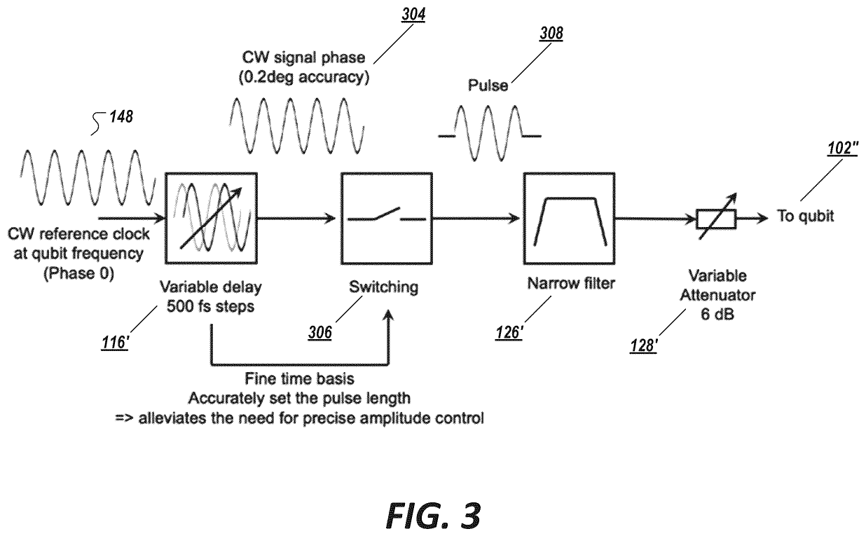

Example Control. FIG. 1B shows an example method of operating the exemplary time-based quantum-bit control of FIGS. 1A-1D. FIG. 3 shows a high level functional description of the method of operation.

In the example shown in FIG. 1B, the control electronics 104′ is implemented with a cryogenic portion 142 that can operate, e.g., between 1 Kelvin and 4.2 Kelvin, and a non-cryogenic portion 144 that operates at or near room temperature, e.g., 300 K (˜80° F.). The control electronics 104′ includes a number of controllers (e.g., M controllers) connected to the quantum processor 102′ (e.g., having M×N qubits) through a set of superconducting wires. The quantum processor 102′ may, e.g., be maintained at near zero kelvin (e.g., 0.02 Kelvin or 20 milliKelvin).

The control electronics 104′ include an exemplary time-based quantum-bit control that employs time delays (rather than amplitude control with sideband modulation of the microwave pulse) to both tune the phase and integrated envelope values of the microwave control signal. The phase θ (rad) may be obtained by delaying by delay t_{d} an input clock CLK0 112 at f_{q} (Hz) such that θ=2πt_{d}f_{q}. The signal-integrated envelope value may be obtained by finely changing the pulse length based on the input clock reference CLK₀ and one of its delayed versions, e.g., via the delay locked loop 112 and variable delayed cell 114. A tunable coarse amplitude control (with, e.g., 6 dB attenuators) allows for maintaining a similar pulse duration between the targeted envelope values.

In FIG. 3 (as well as FIG. 1B), the reference clock 148 (shown as “CW reference clock” 148 in FIG. 3) at the qubit frequency is provided to a variable delay 302 having a pre-defined time-step (shown in the example as 500 fs). The variable delays 116 (shown as 116′) provides CW signal phase 304 that are switched 306 to provide a pulse 308 that is inputted to a filter 126 (shown as narrowband filter 126′) to provide to a variable attenuator 128 (shown as 128′). The output is provided to the quantum processor 102 (shown as “To qubit” 102″).

In the example shown in FIG. 1B, the qubit control signal is a voltage pulse 101 at radio frequencies (f_{q}˜GHz). The input clock CLK₀ 148 at f_{q} is shown fed into a Delay-Locked Loop (DLL) 114 (shown s 114′) formed of N time-delay stages 116 (shown as 116′), comprising, e.g., 32 stages in this example, in which each stage is configured to output a delayed version of the input CLK as CLKₙ (with n from CLK₀ to CLK_{N}) with delays from 0 to 1/2f_{q} corresponding to phases from 0 to π. The variable delay cells 116′ include a set of 32 time-delay circuit elements 117 that are arranged in a cascade that outputs a delayed clock signal to a phase interpolator. As shown, the delay element (D₀) 117 receives a clock signal CLK₀ 148 to provide a delay clock signal CLK₁ (149) and is connected to the next delay element (D₁) 117 to provide a delay clock signal CLK₂ and so forth to the 32^{nd} delay element (D₃₁). The outputs (e.g., shown as CLK₀ to CLK₃₂) are then outputted to an equal delay inverter buffer 119 (not shown, see FIG. 1C) to obtain full 2 pi coverage. Two consecutive CLKs outputted by the buffer-inverter (shown as 121a, 121b) are fed to the phase interpolator.

Finer delays (identically, phases) may be obtained by feeding consecutive clocks, e.g., two consecutive clocks, to the phase interpolator to provide fine phase tuning of the control signal. The pulse length (identically, the integrated envelope value) may be set by the time difference between the, e.g., a rising edge of CLK₀ and the k^{th} rising edge of CLKₙ (with n between 0 and N−1) such that the pulse length is (k+n/N)/f_{q} (also shown as i*D+N/f_{clk}). The pulse length can be adjusted, e.g., between 1 ns to 256 ns with 16 ps steps.

The digital controller 132 may include logic circuits that are configured to output switch control after receiving a trigger signal 150 (shown as “TRG” 150) to start (146) the output pulse at the CLK₀ node to the CLK_{N+1} node that counts N periods of clock cycles CLK₁. When the pulse ends, the logic circuit can query (152) the next pulse from a new sequence that is received from a memory module 134 (shown as “pulse memory” 134). The memory may include a programmable memory, e.g., having 1024 pulse sequences stored.

The architecture of FIG. 1B is capable of precise universal control of a quantum state transition (e.g., a qubit transition), and this approach has the potential of being less power-hungry for a much more compact active area than typical amplitude-based architecture thanks to a full-digital implementation, leveraging the higher power efficiency of modern nanometric CMOS nodes and, eventually, the higher digital power efficiency at cryogenic temperatures. By implementing the controller digitally, the device can be implemented as a compact controller having a lower dissipated power that can facilitate its use in the control of hundreds to thousands of quantum bits. For example, at 4.2-Kelvin operation, a conventional cryogenic fridge configured to draw 1-5 milliWatt of power, the controller and quantum processor can be implemented for 1000 qubits, thus having less than 1 mW/qubit performance.

In some embodiments, the exemplary time-based quantum-bit control may be employed for a fluxonium device or a transmons device. FIGS. 1C and 1D show an example IC architecture for a cryo-CMOS controller 100 (shown as 100c) in accordance with an illustrative embodiment.

Example Computing System. The exemplary system and method may operate with a computing system as a part of device 144 to perform a sequence of computer-implemented acts or program modules running on a computing system comprising a processing unit. The processing unit may be a standard programmable processor that performs arithmetic and logic operations necessary for the operation of the computing device. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

### Example Fluxonium Qubit and Transmon Qubit Operation

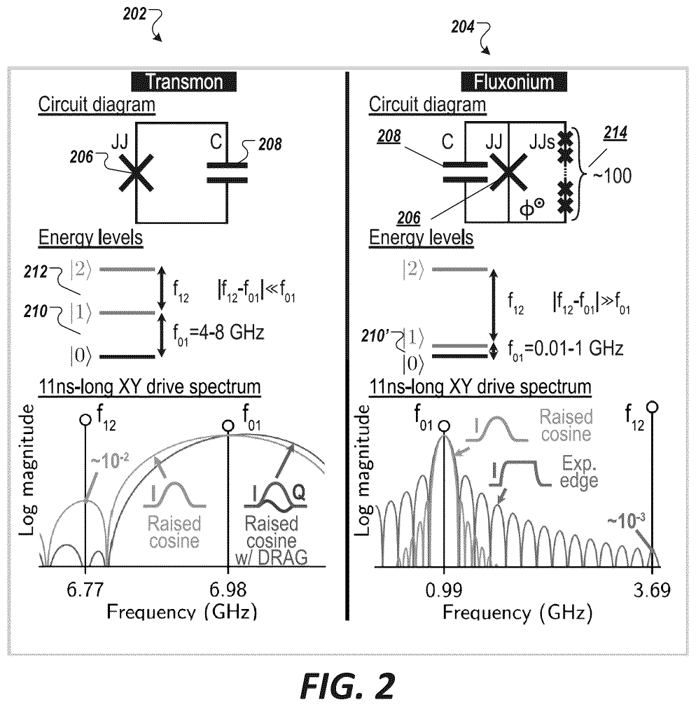

FIG. 2 shows example operations and architectures of the transmon 202 and fluxonium qubits 204, e.g., that may be employed as the quantum processor in FIGS. 1A-1D, among others. The transmon, realized by capacitively shunting 208 a Josephson junction (JJ) 1206, is a non-linear LC resonator with resonant frequency f₀₁ 1210 and anharmonicity in the 4-8 GHz and 200-300 MHz range, respectively. The transmon's limited anharmonicity of ˜5% can constrain the spectral content of the XY signal used to drive the Qubit's f₀₁ transition, as exciting the f₁₂ transition 212 can cause errors. Previous cryo-CMOS quantum controllers generate spectrally-shaped control pulses via direct [3], [4] or SSB upconversion [5], [6] of complex baseband or IF envelopes (e.g., implementing the DRAG protocol); the power consumption and area usage of the high-resolution DACs in these devices often limit their scalability.

The fluxonium employs an additional stack 214 of Josephson junctions serving as a large shunt inductance. This permits realization of a qubit with f₀₁ transitions 210 (shown as 210′) at ˜1 GHz or lower and all other transitions kept at much higher frequencies (>3 GHZ, see FIG. 2) [7]. The fluxonium's lower frequency and higher anharmonicity in comparison to the transmon create the potential for direct generation of the low-GHz-frequency control signal and relaxed specifications for its spectral content (at the cost of a more advanced fabrication process). The exemplary system and method employ a low-power cryo-CMOS quantum controller, e.g, optimized for high-fidelity gates on a fluxonium qubit.

### Example Fluxonium Cryo-CMOS Controller

FIGS. 1C and 1D show the example IC's architecture for an example fluxonium cryo-CMOS controller 104 (shown as 104c), e.g., of the quantum controller device of FIGS. 1A and 1B, in accordance with an illustrative embodiment. The controller 104c can be used with other quantum devices described herein. The controller 104c is configured to produce 1-to-255 ns microwave pulses 308 (shown as 308′) with bandwidth-limited rectangular envelopes and carrier frequency in the 1 GHZ range. The specifications and architecture can achieve phase and integrated amplitude resolution of better than 0.5° and 0.55%, limiting these contributions to the average single-qubit gate error rates to 0.005%. The controller 104c can operate from a clock, e.g., at qubit frequency f₀₁, having phase resolution achieved by the DLL 106 (shown as 106′) and phase interpolator (PI) 118 (shown as 118′) whereas the envelope accuracy is achieved by a pulse shaping circuit 120 (shown as 120′) that provides coarse amplitude control and fine-tuning of the pulse duration (unlike conventional controllers, which use fixed duration with fine amplitude control). A digital controller and sequencer 108 (shown as 108′) enable playback of gate sequences with up to 1024 steps.

FIG. 1C also shows the schematic 160 of the phase generation circuit 118′. The DLL 106′ includes voltage controlled delay line (VCDL) 162, phase frequency detector (PFD) 164, and voltage charge pump 168 (shown as “VCP” 168). The DLL 106′ compares signals from the first and 31st taps (shown as 163a, 163b) of a voltage-controlled delay line (VCDL) after passing these signals through an equal-delay inverter-buffer (EDIB) (119). This locks CLK[0] and CLK[30] at 180° and generates 33 equally delayed clock signals (e.g., 149) of alternating polarity. CLK[30] may be used rather than CLK[32] to ensure full phase coverage in the presence of a phase frequency detector (PFD) or EDIB mismatch, which could lead to a lock angle lower than 180°.

The phase interpolation circuit 118′ includes a pair of 32b demultiplexers (shown as 164a, 164b) to select adjacent clock signals (i.e., CLK[n] and CLK[n+1]) and a switching and EDIB network (170, 172) is used to drive a phase interpolator (PI) 174 with selectable polarity. Each PI unit cell (the example shows 32 in total) includes a multiplexer 176 and a current-limited inverter 178.

The 32 unit-cells 174 may be combined in parallel (shown via inverter 180), with the weighting between the selected phases set by the thermometer encoded 31 b value driving the multiplexer array (the 32^{nd} inverter is driven by CLK[n]) to generate the output CQ signal 304 (shown as 304′). The phase generation circuit has 11 b of control (182), providing a margin in achieving 0.5° accuracy.

FIG. 1D shows a schematic of an example pulse shaper 120′, e.g., of FIG. 1C, configured to receive the phase-shifted clock (e.g., 304′) and apply a rectangular envelope of programmable amplitude and duration. SW1 (184) is configured to gate the digital CW signal 304′. The gated signal 185 is then buffered (via buffers 186) and attenuated by a circuit (187) consisting of a variable resistor R₀ 188 (16 values from 10 to 170 kΩ) connected to a 50 Ω load (189) through a 2:1 doubly-tuned transformer 190. The circuit is configured to reduce the available power by ˜17 dB to ˜29 dB while providing a 50 Ω output match and filtering the pulse spectrum, introducing an exponential rise and fall time of a few ns to the signal envelope, appropriate for large qubit anharmonicity. R₀, Cₚ, and C_{S} are programmed through the SPI bus for static pre-tuning. A 0 to −18 dB attenuator circuit with 6-db steps is provided for coarse amplitude adjustment in real-time. SW2 is incorporated at the output for additional 0 N OFF isolation.

FIG. 1D also shows a schematic diagram of the digital controller 108 (shown as 108″). The pulse memory 134 (shown as gate memory 134′), in one example, contains eight 29b entries, each of which describes a XY or virtual Z (VZ) gate 191. This is sufficient to implement a single-qubit gate set that is universal for quantum computing. In the case of an XY gate, the entry has a VZ flag (192) set low and gate phase (PHASE[0:10]) (193a), amplitude (AMP[0:2]) (193b), and duration (LENGTH[0:7] (193c) and END[0:5] (193d)) parameters set. This last parameter (193c, 193d) is used to select a phase of CLK[0:32] or its conjugate on which to end the pulse, thereby providing fine-tuning of the pulse duration. For a VZ gate (191), the VZ flag (192) is set high, and only the PHASE[0:10] (193a) value is used. The gate memory's 3-bit address line (194a) is controlled by the output of a 1024×3 b (194b) instruction sequence memory 136 (shown as 136′), which is controlled by the sequencer module (195). Both memories are loaded, in the example, through SPI.

When idling, the chip is armed to output an XY pulse, with parameters defined by an entry in the gate memory, which is latched so that PHASE[0:10] (193a), AMP[0:2] (193b), LENGTH[0:7] (193c), and END[0:5] (193d) are set to the correct values. On the rising edge of an externally-applied trigger 150 (shown as 150′), the XY pulse is played back, with the pulse gating waveforms FIRE_{D} (196a) and FIRE_{A} (196b) generated by the firing module 197. When the pulse completes, the sequencer 195 receives a DONE pulse (198a); arms the system for playback of the next XY pulse; and prepares for the following pulse by stepping through any VZ gates, adding the appropriate value to the phase-offset accumulator, then preparing the XY-gate parameters. The armed system waits for the next trigger to fire the pulse.

### Alternative Circuit Topologies

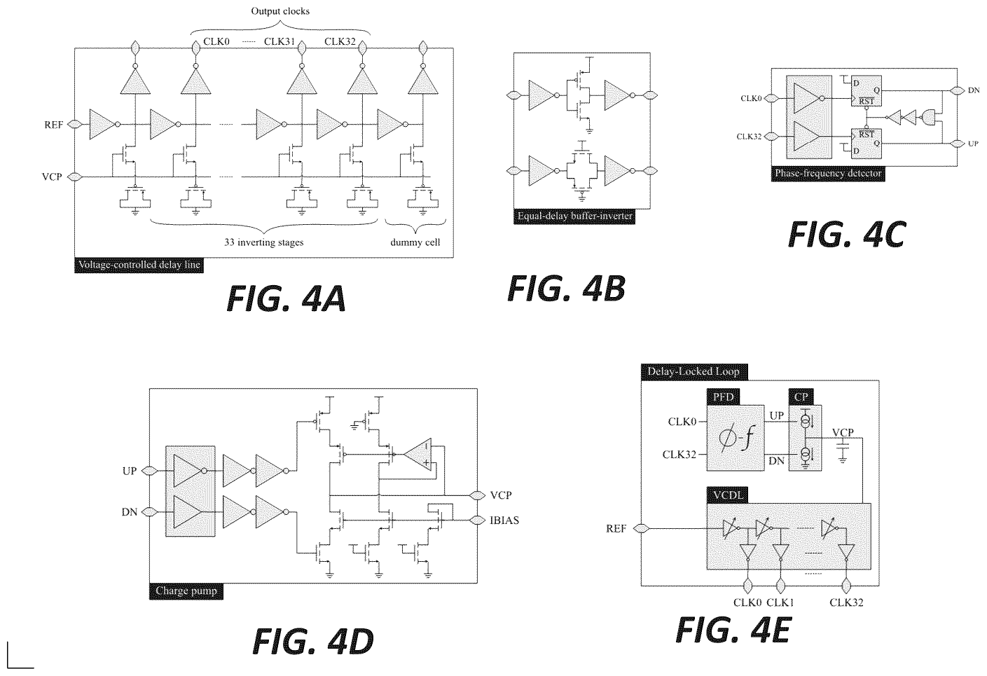

FIGS. 4A, 4B, 4C, 4D, 4E, 5A, 5B, 5C, 6, 7A, 7B, and 7C show alternative circuit implementations for the various controller components of FIGS. 1A and 1B.

Time-based control circuit. FIGS. 4A-4E show five examples of time-based control circuits 106 can be used as an alternative to the DLL 106. Other delayed-lock loop circuit topologies may be used, e.g., a voltage-controlled delay line (FIG. 4A), equal-delay buffer inverter (FIG. 4B), phase-frequency detector (FIG. 4C), charge pump (FIG. 4D). The delay lock loop, e.g., per FIG. 1A, is shown in FIG. 4E. as illustrated in FIG. 4.

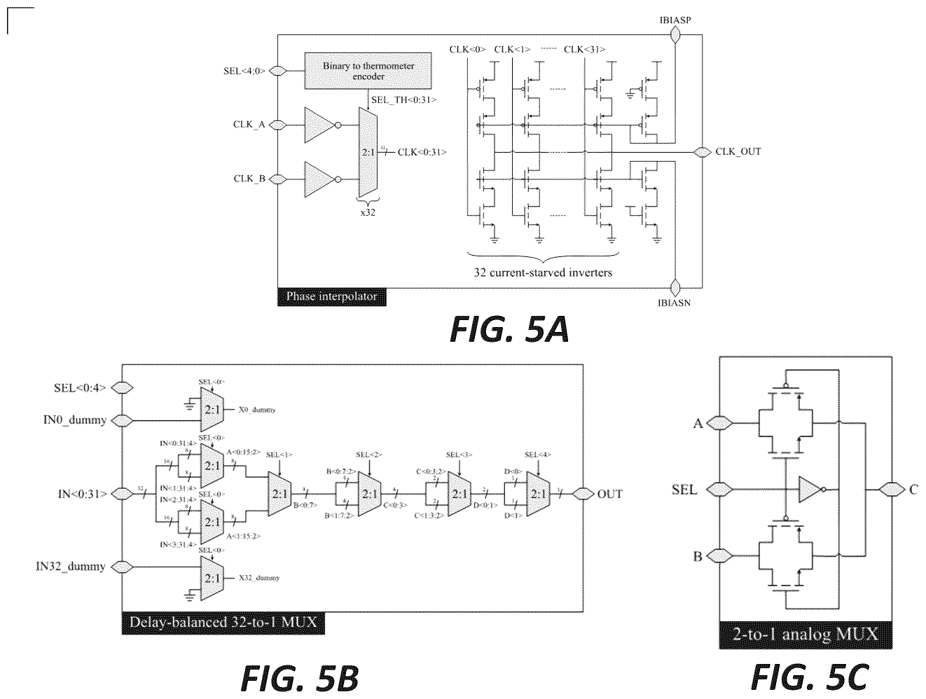

Clock Selection Phase interpolator. FIGS. 5A-5C show three examples of phase interpolation control circuits and equivalent functions can be used as an alternative to the phase interpolation circuit 118. The example of FIG. 1B shows the time-based quantum-bit control circuit implemented as a phase interpolator (FIG. 5A). Other phase interpolation circuits may be used, e.g., a delayed-balanced N−1 multiplexer (FIG. 5B) or a 2-to-1 analog multiplexer (FIG. 5C). FIG. 5A shows a detailed implementation of the phase interpolator.

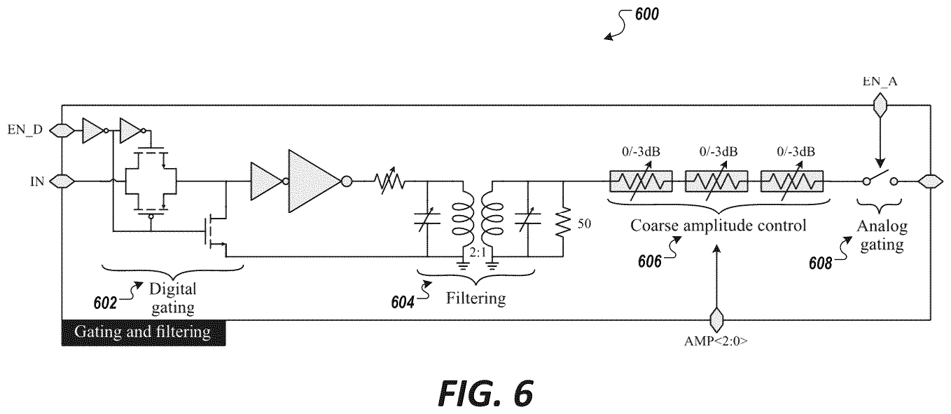

Pulse Shaper. FIG. 6 shows an example alternative circuit for the pulse shpaer comprising Digital-to-Analog Transition, Filtering, and Gating. In the example shown in FIG. 6, the example gating and filtering circuit for the DA transition, filtering, and gating is configured to be coupled to the phase interpolator of any one of FIGS. 1A-1D or FIG. 5. The gating and filtering circuit 600 includes a digital gating circuit 602 that can optionally be used to implement the digital switch 114 of FIG. 1A. The example gating and filtering circuit 600 further includes a filter 604 that can optionally be used to implement the filtering block 116 shown in FIG. 1A.

The digital gating circuit 602 is coupled to the filter 604, and the filter 604 can optionally be implemented as a circuit, including a transformer, as shown in FIG. 6. The output of the filter 604 is coupled to a coarse amplitude control 606 that is gated by an analog switch 608. The analog switch 608 can optionally be used to implement the analog switch 120 shown in FIG. 1A. It should be understood that any combination of the digital gating circuit 602, filter 604, course amplitude control 606 and analog switch 608 can be used in various implementations of the present disclosure.

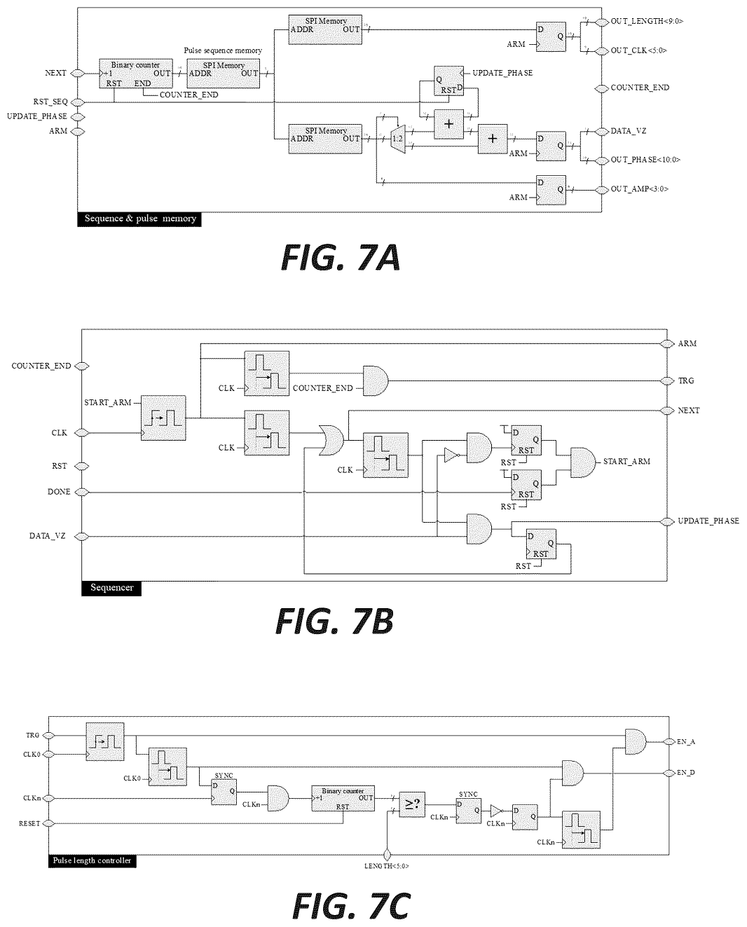

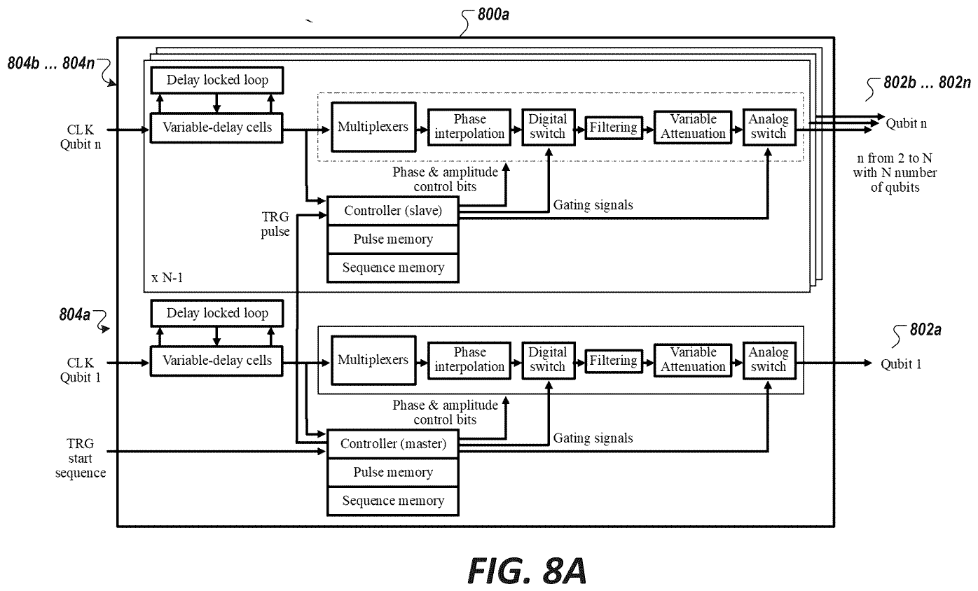

Sequence Controller and Memory. FIG. 7A-7C show three example controllers for the quantum circuit 100, e.g., of FIGS. 1A-1D, and FIGS. 4-6. FIG. 7A shows an example sequence controller and a memory circuit that is coupled to the delayed lock loop circuit or other circuit delay circuit described herein. The controller and memory circuit is implemented with binary counters, memory modules, multiplexers, flip-flops, and digital logic circuitries.

FIG. 7B shows the sequencing circuitry managing the pulse loading sequence and update of the pulse parameters following the sequence and pulse memory output that employs only a sequencer implemented with digital logic circuits comprising pulse detectors, flip-flops, and digital logic circuitries.

FIG. 7C shows the pulse duration control taking as input one of the DLL CLK and the length bits from the sequence and pulse memory implemented with a pulse detector, binary counter, comparator, flip-flops, and digital logic circuitries.

### Example Large-Scale Time-based Control for Qubit Quantum Processor System

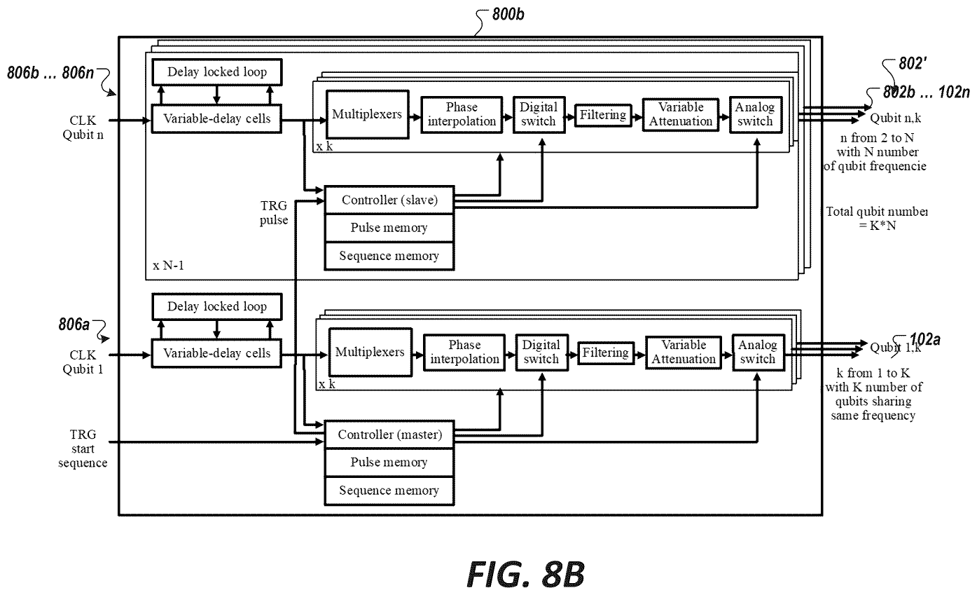

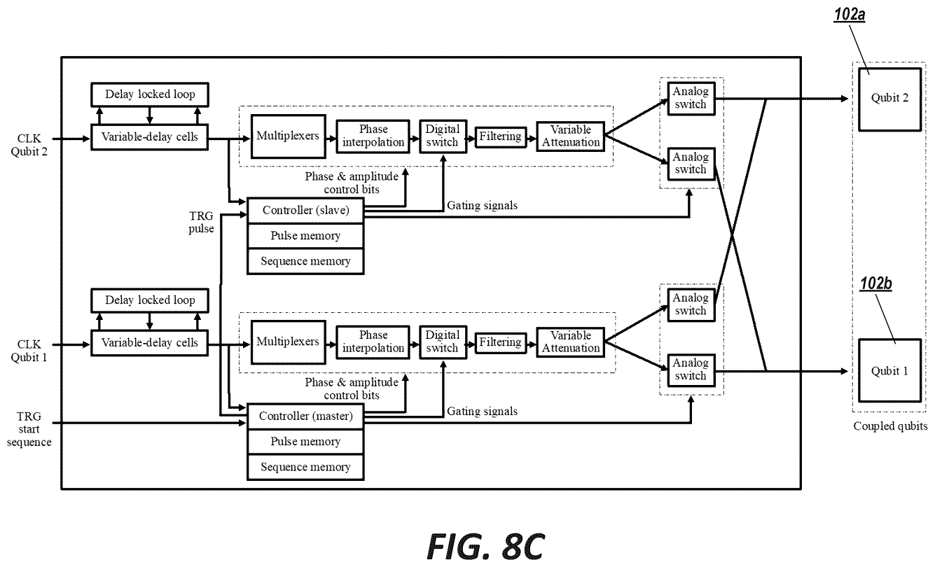

FIGS. 8A-8C show an N-qubit architecture 800a, a K×N-qubit architecture 800b, and a 2-qubit architecture 800c, respectively, that be fabricated from the quantum circuit controllers of FIGS. 1A-1D, 4A-4D, 5A-5C, 6, and 7A-7C.

N-qubit architecture. FIG. 8A shows a time-based N-qubit control 800a for a qubit quantum Processor system with N-qubits 802 (shown as 802a, 802b, . . . , 802n). As shown in FIG. 8A, all qubits can be configured with a different frequency. The control may employ a common pulse TRG to trigger the simultaneous pulses. The N-qubit control 800 employs an N number of 1-Qubit controllers, where each 1-Qubit controller can include the structure of the 1-Qubit quantum device 100 (shown as 804a, 804b, . . . , 804n), e.g., shown in FIG. 1A-1D or FIGS. 2-7. The first Qubit control quantum device 804a can optionally be set as the master that then controls the other Qubit control 804b, . . . , 804n (and any number of other Qubit control quantum devices from 2 to N) that can operate in slave mode to the first Qubit control.

K×N-qubit architecture. FIG. 8B shows a time-based control for a qubit quantum processor system with K×N-qubit 800b. In the example shown in FIG. 8B, each of the K-qubit controllers 806a, . . . , 806n share a common frequency as a group N for a set of controllers/qubits to which each group N is configured to operate with a different frequency independent of another group.

The control can employ a common pulse TRG to trigger the simultaneous pulses. While in FIG. 8B, the K×N-qubit control 800′ can employ a K×N number of 1-Qubit controllers 806a, . . . 806n, alternatively, the K×N qubit control 800b can share circuitry such as the DLL for the k-qubit control at constant frequency. The first k-Qubit control 806a can be set as the master(s) that then control the other k-Qubit control 100n (e.g., any number of controls numbered 2 to N) that can operate in slave mode to the respective set of the first k-Qubit control.

Two-Qubit Gates Controller. FIG. 8C shows an example method of operation for two-qubit gates (e.g., using a two-qubit control 800c that can generate entanglement between two coupled qubits 102 (shown as 102a, 102b) via the cross-resonance effect. The implemented gate is a CNOT type.

### Experimental Results and Examples

A study was conducted to develop and evaluate a time-based controller architecture enabled by the qubit frequencies <2 GHz. The controller can provide a rotation angle that is set by fine pulse duration (15 ps) and coarse amplitude (factor of 2's). The controller can employ pulse shaping using LC filtering. The study fabricated the control chip in CMOS FD-SOI 22 nm technology for operation at 300 and 4.2 K and is configured to provide low power operation per active Qubit of 0.6 mW (×3.3 improvement from literature). In the study, for the embedding and test preparation, the chip is wire-bonded in a module with increased filtering and high input/output isolation. The chip is connected to room-temperature instrumentation for integration and qubit validation test.

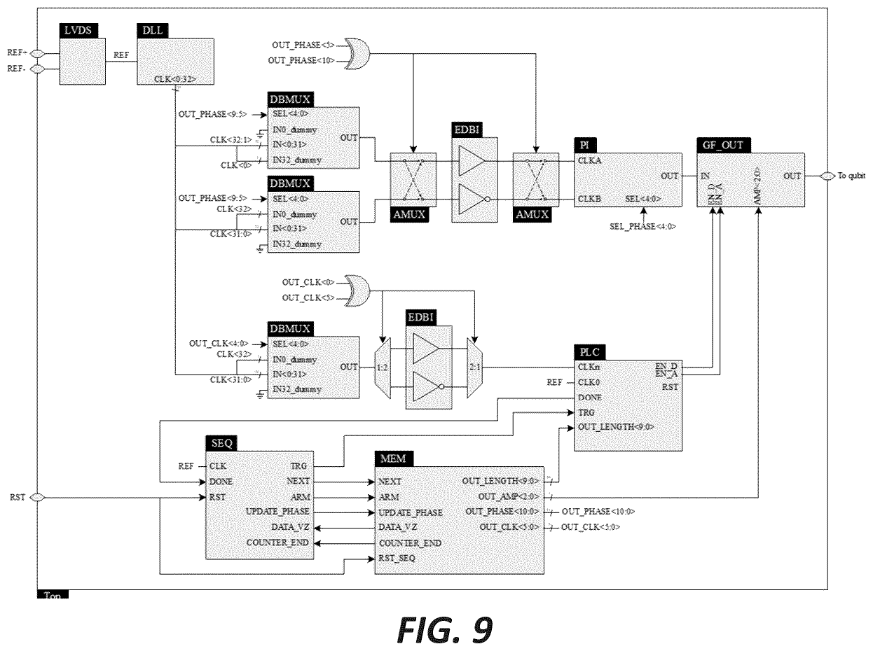

A first version of the architecture has been implemented with an advanced CMOS technology node, and it has been characterized and tested on a quantum device. FIG. 9 shows an example implementation of the time-based qubit controller in an integrated circuit for a 1-qubit device, employed in the study. The chip was able to control the qubit state of a fluxonium qubit with a transition frequency of 1 GHz for a total power budget of 0.8 mW/Qubit (below any demonstrated implementation so far). A second version has been manufactured, shown in FIGS. 1C and 1D

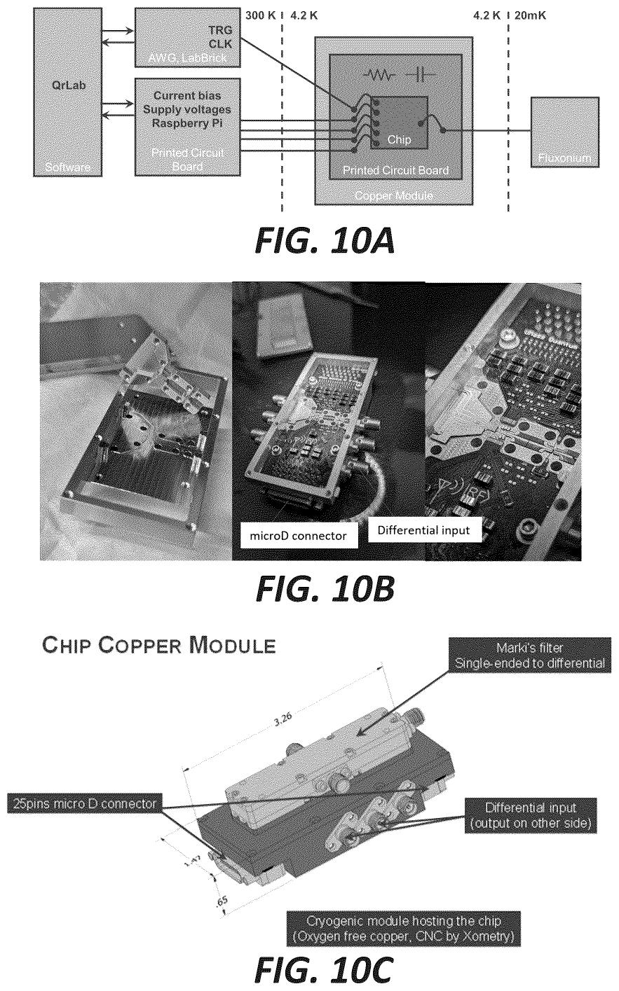

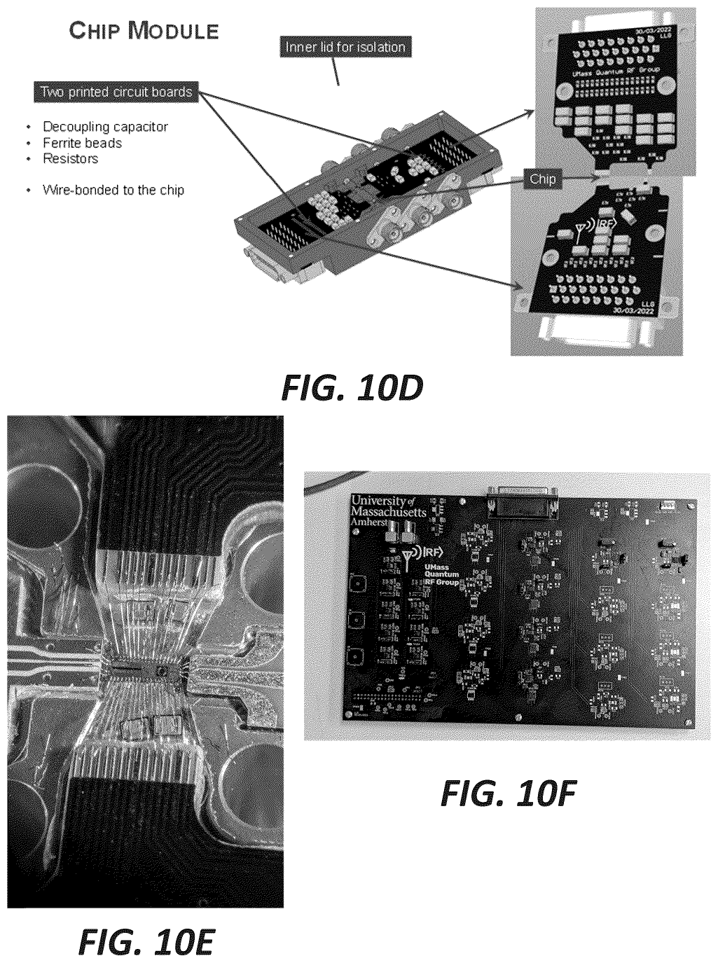

Example test setup. FIG. 10A shows an example setup employed in the study. The software stack controls a signal generator (i.e., an adjustable signal generator manufactured by LabBrick), regulated power supplies, and a Raspberry Pi computer. The waveform generator and current bias supply voltage board were coupled to an instrumentation test board having the exemplary controller chip that is coupled to a fluxonium device. The controller chip was encased in a copper module that is immense in cryogenic fluid at 4.2 K.

FIG. 10B shows photographs of a cryogenic copper module and instrumentation printed circuit board. FIG. 10B shows a photograph of the gold-plated copper cryogenic module and the module with the printed circuit board installed. The printed circuit board included filtering such as capacitors and ferrite beads. The module included small micro D connectors. FIGS. 10C and 10D show engineering drawings of the copper cryogenic module. FIG. 10E shows a zoomed-in image of for the time-based Qubit control chip. FIG. 10F shows the instrumentation board with an 8× low noise voltage supply, a 4× current source to bias the chip, and an 8× DC voltage source.

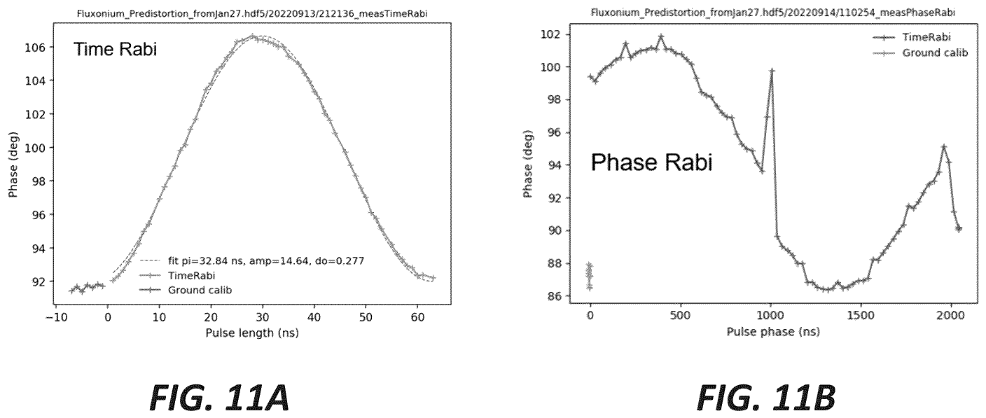

FIGS. 11A-11B shows experimental results showing a 2-Q fluxonium device, driving upper Qubit at 1 GHz at half flux sweet spot where the total power is ˜0.8 mW. FIG. 11A shows time Rabi, and FIG. 11B shows phase Rabi.

FIG. 11 shows experimental results showing a 2-Q fluxonium device, driving upper Qubit at 1 GHz at half flux sweet spot. The total power is ˜0.8 mW.

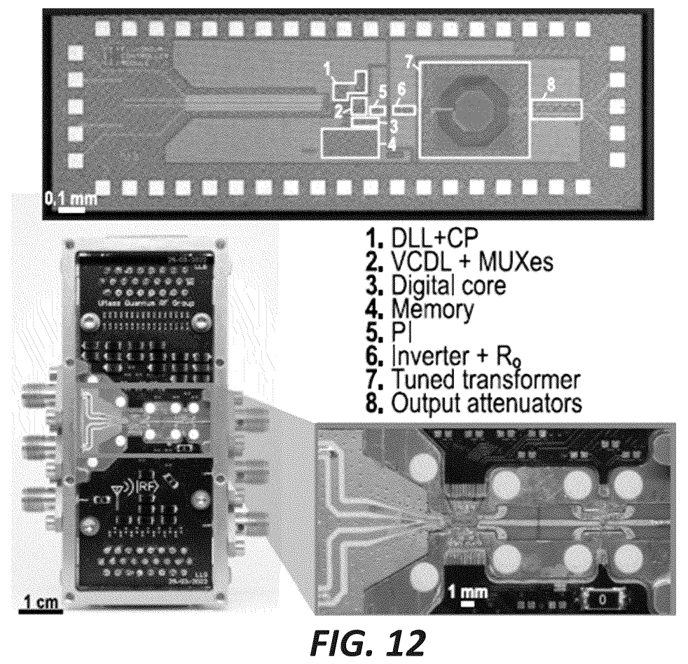

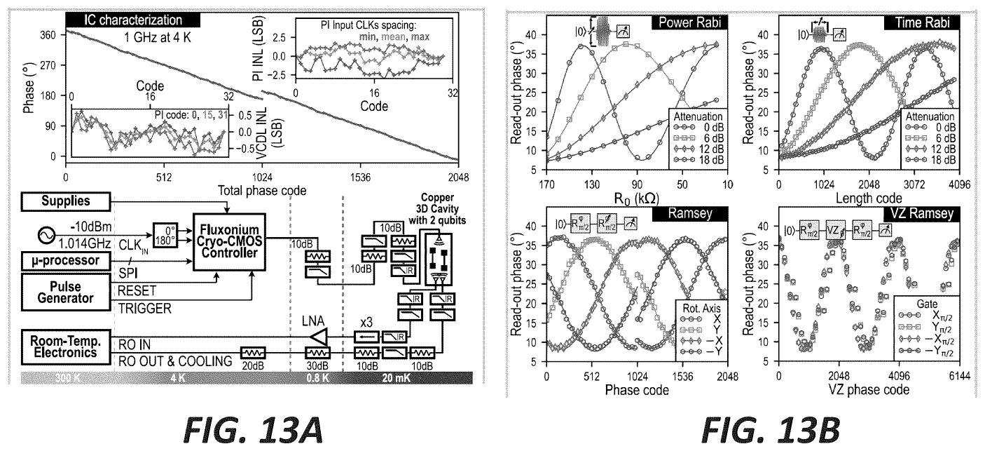

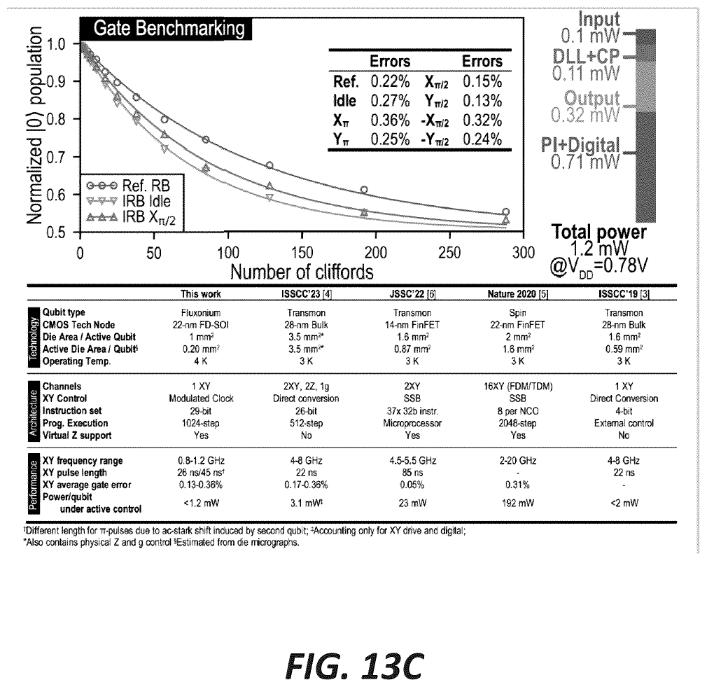

Fabricated system. The study fabricated a prototyped IC in a 22 nm FD-SOI CMOS technology. FIG. 12 shows a die micrograph of the prototyped IC. After packaging it in a coaxial module, the IC was first characterized electrically at 4 K. FIG. 13A shows example results for the phase vs code. A piecewise monotonic dependence of the output phase occurred due to the combination of the VCDL and PI, with a jump at mid-range due to the redundant phases. The redundant combination of the VCDL and PI achieves a precision of ˜0.4°, meeting the requirement for a gate fidelity of 99.995%. However, the INL of the full 11 b phase generator was ˜4.7° over each half of the 11 b code. The use of arbitrary VZs reduces the achievable fidelity to 99.5%, limited by the INL of each half, assuming an additional VZ gate is used each time the PHASE code jumps from one half to the other. For the ˜1 GHz clock frequency, the 0.7 b INL of the VCDL ensures an integrated envelope accuracy of 0.55% for pulses as short as 3 ns.

FIG. 13A also shows the setup used for quantum control experiments. A quantum processor chip within a 3D microwave cavity is used and contains two fluxonium qubits having qubit frequency f₀₁ of 576 MHz and 1014 MHz, respectively. Both qubits have >2.6GHz anharmonicity. For each shot of the experiment, we initialize both qubits to |0 [symbol] by driving a multi-photon transition at ˜3.5GHz via the readout port for 25 μs [8], then perform variable operations on the 1014 MHz Qubit with the cryo-controller, followed by standard dispersive readout at the cavity frequency of ˜7.6GHz. This Qubit has coherence times of 37/8 μs (T₁/T₂, EeHO)). The lower Qubit has 60 μs T₁ and remains idle, but its imperfect initialization may affect gate performance due to a XZ coupling.

FIG. 13B shows results of quantum control experiments. Here, each point is an average of 15,000 shots. Rabi oscillations were observed vs pulse amplitude (with resistor Ro from 10-to-170 k [symbol] ) and duration (0-to-64 ns) with attenuation stepped from 0-to-18 dB, confirming the IC's ability to accurately control pulse amplitude and duration. Ramsey experiments were carried out both by sweeping the phase of the Ramsey recovery pulse and by inserting a VZ gate between two π/2 pulses, validating the IC's phase control and VZ gate capabilities. The jumps in the Ramsey curve at codes 1023 and 2047 are due to the DLL's redundant phase.

FIG. 13C shows randomized benchmarking results for a gate set composed of X_{π/2}, −X_{π/2}, Y_{π/2}, −Y_{π/2}, X_{π}, and Y_{π}. To mitigate the impact of a dynamic ZZ coupling between the target and idling qubits (a limitation of the global drive field in the 3D cavity device), we use the same amplitude but different lengths for π and π/2 pulses (45 and 26 ns). The average gate-error rate is 0.22±0.005% with individual gate errors of 0.13 to 0.36% obtained through interleaved randomized benchmarking. These error rates are limited by the qubit coherence times, which set a lower bound of 0.12% and 0.21% for 26 and 45 ns gates, respectively.

The IC performance is compared in FIG. 13C to other quantum controllers that have been characterized with qubits. The IC provides competitive performance, achieving qubit-limited gate performance while consuming lower area and power than other state-of-the-art ICs.

### Conclusion

Each and every feature described herein, and each and every combination of two or more of such features, is included within the scope of the present invention, provided that the features included in such a combination are not mutually inconsistent.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with certain embodiments and specific examples, it is not intended that the scope be limited to the particular embodiments set forth, as the embodiments herein are intended in all respects to be illustrative rather than restrictive.

The following patents, applications, and publications as listed below and throughout this document are hereby incorporated by reference in their entirety herein.

### REFERENCES

[1] Quantum Machine, OPX (amplitude-based approach with IQ mixing and AWGs) (https://www.quantum-machines.co/opx+/)
[2] Zurich Instruments, Qubit controller (amplitude-based approach with IQ mixing and AWGs) (https://www.zhinst.com/americas/en/products/shfqc-qubit-controller)
[3] University of Chicago, QICK (direct digital synthesis of pulses) (https://github.com/openquantumhardware/qick)
[4] D. J. Frank et al., “A Cryo-CMOS Low-Power Semi-Autonomous Qubit State Controller in 14 nm FinFET Technology,” 2022 IEEE International Solid-State Circuits Conference (ISSCC), San Francisco, CA, USA, 2022, pp. 360-362, doi: 10.1109/ISSCC42614.2022.9731538. (https://iceexplore.ieee.org/document/9731538)
[5] J.-S. Park et al., “13.1 A Fully Integrated Cryo-CMOS SoC for Qubit Control in Quantum Computers Capable of State Manipulation, Readout and High-Speed Gate Pulsing of Spin Qubits in Intel 22 nm FFL FinFET Technology,” 2021 IEEE International Solid-State Circuits Conference (ISSCC), San Francisco, CA, USA, 2021, pp. 208-210, doi: 10.1109/ISSCC42613.2021.9365762. (https://ieeexplore.ieee.org/document/9365762)
[6] B. Patra et al., “19.1 A Scalable Cryo-CMOS 2-to-20 GHz Digitally Intensive Controller for 4×32 Frequency Multiplexed Spin Qubits/Transmons in 22 nm FinFET Technology for Quantum Computers,” 2020 IEEE International Solid-State Circuits Conference-(ISSCC), San Francisco, CA, USA, 2020, pp. 304-306, doi: 10.1109/ISSCC19947.2020.9063109 (https://ieeexplore.ieee.org/document/9063109)
[7] J. C. Bardin et al., “29.1 A 28 nm Bulk-CMOS 4-to-8 GHZ [symbol] mW Cryogenic Pulse Modulator for Scalable Quantum Computing,” 2019 IEEE International Solid-State Circuits Conference-(ISSCC), San Francisco, CA, USA, 2019, pp. 456-458, doi: 10.1109/ISSCC.2019.8662480. (https://iecexplore.ieee.org/document/8662480)
[8] Stefanazzi, Leandro, et al. “The QICK (Quantum Instrumentation Control Kit): Readout and control for qubits and detectors.” Review of Scientific Instruments 93.4 (2022): 044709. (https://arxiv.org/abs/2110.00557)
[9] D. J. Frank et al., “A Cryo-CMOS Low-Power Semi-Autonomous Qubit State Controller in 14 nm FinFET Technology,” 2022 IEEE International Solid-State Circuits Conference (ISSCC), San Francisco, CA, USA, 2022, pp. 360-362, doi: 10.1109/ISSCC42614.2022.9731538. (https://iceexplore.ieee.org/document/9731538)
[10] J.-S. Park et al., “13.1 A Fully Integrated Cryo-CMOS SoC for Qubit Control in Quantum Computers Capable of State Manipulation, Readout and High-Speed Gate Pulsing of Spin Qubits in Intel 22 nm FFL FinFET Technology,” 2021 IEEE International Solid-State Circuits Conference (ISSCC), San Francisco, CA, USA, 2021, pp. 208-210, doi: 10.1109/ISSCC42613.2021.9365762. (https://ieeexplore.ieee.org/document/9365762)
[11] B. Patra et al., “19.1 A Scalable Cryo-CMOS 2-to-20 GHz Digitally Intensive Controller for 4×32 Frequency Multiplexed Spin Qubits/Transmons in 22 nm FinFET Technology for Quantum Computers,” 2020 IEEE International Solid-State Circuits Conference—(ISSCC), San Francisco, CA, USA, 2020, pp. 304-306, doi: 10.1109/ISSCC19947.2020.9063109. (https://ieeexplore.ieee.org/document/9063109).
[12] J. C. Bardin et al., “29.1 A 28 nm Bulk-CMOS 4-to-8 GHZ [symbol] mW Cryogenic Pulse Modulator for Scalable Quantum Computing,” 2019 IEEE International Solid-State Circuits Conference-(ISSCC), San Francisco, CA, USA, 2019, pp. 456-458, doi: 10.1109/ISSCC.2019.8662480. https://ieeexplore.ieee.org/document/8662480
[13] F. Arute et al., “Quantum supremacy using a programmable superconducting processor,” Nature, vol. 574, no. 7779, pp. 505-510, October 2019.
[14] R. Acharya et al., “Suppressing quantum errors by scaling a surface code logical qubit,” Nature, vol. 614, no. 7949, pp. 676-681, February 2023.
[15] J. Bardin et al., “A 28 nm Bulk-CMOS 4-to-8 GHz <2 mW Cryogenic Pulse Modulator for Scalable Quantum Computing.” ISSCC, pp. 456-457, February 2019.

What is claimed is:

1. A system comprising:
a quantum processor; and
control electronics coupled to the quantum processor to resonantly or close to resonantly drive the quantum processor via a radiofrequency output (e.g., radiofrequency pulsed output) to manipulate a quantum state, the control electronics comprising:
a signal generator; and
time-based control circuits coupled to the signal generator to generate the radiofrequency output with tunable phase and integrated envelope values at a frequency close or equal to the quantum transition frequency to manipulate a quantum state.

2. The system of claim 1, wherein the time-based control circuits comprises:
a set of cascading time delay circuits configured to receive a clock signal from the signal generator to generate a set of consecutive time-delayed clock signals; and
a multiplexor and phase interpolator configured to selectively delay the set of consecutive time-delayed clock signals to control and tune the phase and integrated envelope of the radiofrequency output.

3. The system of claim 2, wherein the control electronics are configured to provide less than 1 mW/qubit.

4. The system of claim 1, wherein the quantum processor comprises a set of fluxonium devices or a set of transmon devices with more than 100 qubits.

5. The system of claim 2, wherein the set of cascading time delay circuits is implemented in an integrated circuit, the set of cascading time delay circuits comprising a delayed-locked loop circuit, a voltage-controlled delay circuit, an equal-delay buffer inverter circuit, a phase-frequency detector circuit, or a charge pump circuit.

6. The system of claim 1, wherein the control electronics further includes a sequence controller and memory circuit coupled to the set of cascading time delay circuits, the sequence controller configured to retrieve a set of pulse and sequence outputs from the memory circuit and provided the retrieved set of pulse and sequence outputs as phase and amplitude control bits to the multiplexor, the phase interpolator, and the output circuitry.

7. The system of claim 1, wherein the control electronics are configured as a 1-qubit controller.

8. The system of claim 1, further comprising N−1 control electronics for an N-qubit controller having N number of qubits configured to operate at different frequencies, wherein the control electronics are configured as a master mode and the N−1 control electronics configured as a slave mode.

9. The system of claim 1, further comprising K×N control electronics for a K×N-qubit controller having K number of Qubit configured to operate at a shared frequency, and each of the K qubits has an N number of Qubit configured to operate at different frequencies, wherein the control electronics is configured as a master mode and the K×N−1 control electronics configured as a slave mode, and wherein at least one circuitry is shared for same-frequency qubits.

10. The system of claim 1, wherein the quantum processor comprises a set of transmon devices.

11. A method comprising:
resonantly or close to resonantly driving a quantum processor via a radiofrequency output via control electronics to manipulate a quantum state; and
adjusting the radiofrequency output via time-based controls by tuning phase and integrated envelope of the radiofrequency output at a frequency close to or equal to the quantum transition frequency to manipulate a quantum state.

12. The method of claim 11, wherein the method comprises:
receiving a clock signal from a signal generator;
generating a set of consecutive time-delayed clock signals; and
selectively delaying the set of consecutive time-delayed clock signals to control and tune the phase and integrated envelope of the radiofrequency output.

13. The method of claim 12, adjustments consume less than 1 mW/qubit operation.

14. The method of claim 11, wherein the quantum processor comprises a set of transmon or fluxonium devices with more than 100 qubits.

15. The method of claim 12, wherein generating a set of consecutive time-delayed clock signals is performed using a delayed-locked loop circuit, a voltage-controlled delay circuit, an equal-delay buffer inverter circuit, a phase-frequency detector circuit, or a charge pump circuit.

16. The method of claim 1, further comprising:
retrieving a set of pulse and sequence outputs from a memory circuit; and
providing the retrieved set of pulse and sequence outputs as phase and amplitude control bits to adjust the radiofrequency output.

17. The method of claim 11, wherein the operation controls 1 qubit.

18. The method of claim 11, wherein the operation, as a master mode, additionally controls N−1 Qubit in slave mode.

19. The method of claim 11, wherein the operation, as a master mode, additionally controls (K×N)−1 qubit in slave mode.

20. The method of claim 11, wherein the quantum processor comprises a set of transmon devices.
